(19) United States
(12) Patent Application Publication
(10) Pub. No.: US 2015/0227894 A1
(43) Pub. Date: Aug. 13, 2015

(54) AUTOMATED CUSTOMER COMMUNICATION

(71) Applicant: Michigan Software Design LLC, Royal Oak, MI (US)

(72) Inventors: William D. Mapes, JR., Royal Oak, MI (US); Patrick J. Southward, Grosse Ile, MI (US)

(21) Appl. No.: 14/614,764

(22) Filed: Feb. 5, 2015

Related U.S. Application Data
(60) Provisional application No. 61/937,247, filed on Feb. 7, 2014.

(51) Int. Cl. G06Q 10/00

(52) U.S. Cl. CPC G06Q 10/20

(57) ABSTRACT

A system may provide automated communication of a vehicle status with a customer. The system may comprise a computing device, a database, a user interface, and a server. The computing device configured to receive contact information of the customer and vehicle status from a vehicle service facility. The database may be in communication with the computing device and configured to store the contact information and vehicle status. The user interface may be in communication with the database and configured to present the vehicle status. The server may be configured to automatically send a link associated with the internet dashboard.

### CROSS-REFERENCE TO RELATED APPLICATIONS

This application claims priority to U.S. Provisional Patent Application No. 61/937,247, filed Feb. 7, 2014, the contents of which are hereby incorporated in their entirety.

### FIELD OF TECHNOLOGY

Systems and methods for facilitating automated customer communications, more particularly, with vehicle service facilities regarding vehicle status.

### BACKGROUND

The automotive service industry is a substantial industry with significant growth expected in upcoming years. The competitors for this market are dealerships, independent garages, and aftermarket chains. Competition between these entities is competitive with these entities delivering similar services while occupying the same geographical areas, servicing the same vehicle types, and vigorously competing on price.

For this industry, the customer segment that contributes the greatest portion to dealership service receipts (e.g., aging buyers performing manufacturer suggested warranty work on new vehicles) is the least profitable and shrinking market segment. Additionally, the most profitable segment (e.g., young buyers with aging vehicles) is becoming less interested in car dealerships. Service work as a percentage of total dealer receipts is declining. There is an aging dealer loyalist population. Dealerships are successful with customers over the age of 55, which is the least profitable customer segment. Young people under 34 favor the aftermarket. Customer pay work peaks with a vehicle age of 3-7 years. Customer loyalty rates in franchised dealers are at 23%, but account for 62% of the total service revenue. There are several trends that dealerships must respond to in order to stay competitive in the customer-pay service business.

Usage of smart phones and social media is increasing while phone calls are becoming less effective for the vehicle service industry. To accommodate for this, service facility employees may occasionally communicate with customers directly via text message from their personal devices. This method may be convenient for customers but retention of this customer information is risky for dealerships considering the turnover rates of employees. When a service facility employee leaves, the customer information leaves with the employee's personal device.

Dealerships are struggling to reach young, mobile customers. The current value proposition of “enjoy our amenities while our experts service your vehicle” isn't resonating with the most profitable market segment. By implementing new technology, the value proposition may be shifted to satisfy the needs of dealerships such as attracting a younger customer base, enhancing customer loyalty rates, and capturing customers from other sources or market segments. Dealers must shift their value proposition to attract and retain younger, more profitable customers. By implementing mobile and social technologies, dealers may establish deeper relationships that may create more repeat, profitable customers.

There are major gaps in communication between dealers and customers. As technology evolves to a more mobile, on-demand nature, businesses that do not effectively communicate may be quickly discarded as the market seeks efficiency. Common areas of disconnect that drive down loyalty rates include: communication on when the customer's vehicle is complete, customer must leave work or other priorities to acquire vehicle, dealer wants to discuss vehicle at inopportune times for customer, and dealer advertises loaner or shuttling services but does not have adequate loaner or shuttling services.

There is a need in the art for systems and methods for enhancing communication and relationships between dealers and customers to address or solve the above problems.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates an exemplary communication system of the present disclosure;

FIG. 2 illustrates an exemplary vehicle notification process of the present disclosure;

FIG. 3 illustrates a graphical representation of an exemplary user interface; and

FIG. 4 illustrates a graphical representation of another exemplary user interface.

### DETAILED DESCRIPTION

Exemplary embodiments may include systems and methods for providing a web-based, customer communication platform integrated into software of existing Dealership Management Systems (DMS) to help automotive service facilities (e.g., dealerships) better communicate with customers, increase customer satisfaction, and increase profitability of their operations. Communications may be provided through e-mail, text message, or voice to provide an improved communication platform for the automotive industry.

A system for automated communications with a customer is provided. The system may include a computer configured to receive contact information of the customer and a vehicle status from a vehicle service facility, a database connected to the computer and configured to store the customer contact information and vehicle status, an internet dashboard connected to the database and configured to reflect the vehicle status, and a server configured to automatically send a link for the internet dashboard to a mobile device associated with the customer contact information.

Methods for automated communications with a customer are also contemplated. A method may include providing a user interface connected to a database configured to receive multiple channels of communication data, combining the channels of communication data into one communication thread; and displaying the communication thread on the user interface. The channels may include e-mail, SMS, and voice communications. The user interface may include a display configured to present an internet dashboard. A further method may include providing a computer configured to access a database of a vehicle service facility, the database being connected to an internet dashboard including any e-mail, SMS, and voice communications regarding the vehicle status, updating the vehicle status on the database with the computer in response to at least a portion of task being performed by the vehicle service facility, reflecting the updated vehicle status on the internet dashboard, automatically sending a link for the internet dashboard to the customer, receiving a customer response from the customer, reflecting the customer response on the internet dashboard, and automatically sending a link for an invoice on the internet dashboard to the customer in response to completion of the task is indicated to the computer by the vehicle service facility. Also, a method may include entering customer contact information into a computer connected to a database of a vehicle service facility, providing a vehicle status to the computer by the vehicle repair facility, and automatically sending the vehicle status from the database to a mobile device associated with the customer contact information. Another method may include receiving customer contact information into a computer connected to a database of a vehicle service facility with the database being connected to an internet vehicle dashboard, receiving a vehicle status into the database from the vehicle service facility, providing the vehicle status on the vehicle dashboard, and automatically sending a link for the internet dashboard to a mobile device associated with the customer contact information.

The system may deliver automated communications (e.g., vehicle service updates) to customers via electronic mail (“e-mail”), phone or voice call, or short message service (“SMS,” also interchangeably referred to herein as text message). As updates are received by the system, communications may be automatically generated with minimal or without human initiation. This may be accomplished by integrating with existing dealership management software to obtain progress reports in real-time or near real-time. Users may interact with an easy-to-use user interface that may facilitate conversations with customers, deliver custom content to customers, or manage ongoing marketing campaigns with their client base. The system may combine multiple channels of communication data into one communication thread, for example, by combining e-mail, phone, and SMS data on a database connected to a user interface. The user interface may include the internet dashboard. This enables dealerships to retain control of the data and more effectively manage the customer relationships.

The system may provide improved visibility, customer communication, automated invoicing, human resources allocation, and service facility reputation and relationships with customers. Work performed on a vehicle may be visible to each customer across the vehicle repair process, which may facilitate efficient communication leading to vehicle service corresponding with each customer's needs. Also, the system may automatically generate and report (e.g., via text message, e-mail, or phone) vehicle status updates as tasks are completed and invoices and related documents upon completion of the vehicle. Furthermore, service facilities may not have to allocate as many people to the reporting or communication tasks thereby allowing them to re-allocate resources to other activities. The system may also track repair activities and customer feedback relative to milestones or other service facilities, which may allow the service facility to proactively adjust for changing customer trends. Improved communication may allow customers to be advised of vehicle statuses easily and at the preferred frequency, thereby improving reputation and customer relationships with the service facility.

Embodiments may also allow customers to receive vehicle progress status via internet dashboard, depending on customer preferences. The system herein may allow the customer to track vehicle service over with the internet dashboard without requiring the download of a specific mobile application. The vehicle updates may be posted to the internet dashboard to keep the customer, service technician, and service writer connected in regard to the vehicle status.

Customers may approve and pay for the work performed on their vehicle, for example, with their mobile device. As the service facility examines the vehicle and finds additional services needed, the service facility can push those additional services to the customer for approval. This may reduce delays in the repair process, as the service facility may not have to stop working on customer vehicles to wait for approval. The system may also be configured to capture relevant customer information or preferences. The system may allow service facilities to easily communicate with customers via the customer's preferred channel while consolidating communications, for example, by reducing communication types and the associated platforms required for each type.

Along with the declining effectiveness of phone calls, e-mails directing consumers to standardized content may not capture consumer attention. The system herein may deliver customized e-mails, text messages, or voice calls based on the individual customer needs. Included in text messages and e-mails may be a URL to a webpage. When a consumer clicks the link, the system may post dynamic content generated for that individual customer. Examples include vehicle status updates, a video of the vehicle in service, or promotional content for customer interaction.

The system may feature an outbound marketing campaign management functionality that may deliver pre-configured or customized text or e-mail message directly to the customer. The system may allow the service facilities to be in ongoing communication with the customer thereby increasing the likelihood of retaining service business and ultimately selling the customer another vehicle.

Upon vehicle completion, the system may encourage users to post their successful service visit directly to their favorite social feeds. This allows service facilities to capture the positive emotion of a good service interaction and increase their social reputation.

The system may establish direct integrations to Dealership Management Systems (DMS) providers. The system may also use their specifications to perform the integrations. Furthermore, the system may extract relevant information and setup marketing campaigns or other tracking items. Depending on the communication preference indicated by the customer, the system may deliver actionable messages via the selected channel. The system may track customer's interactions with these messages and the system may notify the service facility of the customer's activity. The system may establish direct integrations to original equipment manufacturers (OEMs), which may allow specific vehicle information to be populated into the system.

The system may utilize a technology provider for web-based text and voice communication. Each service facility may receive a long-code or a short-code phone number with the option of porting their existing phone number to system. They may perform all communication with the customer via this new phone number and through system's web-based platform.

The system may be configured for mobile devices. Each service facility may receive a payment gateway sub-account through which mobile payments may be captured, for example, by using authorize.net. HTML e-mails and webpages may be developed using web standards. HTML webpages may be developed using any suitable web standards. The dealer-facing system platform may be developed using closed or open-source web services and languages such as HTML, Javascript, and .NET. The design may be responsive to fit different device display resolutions.

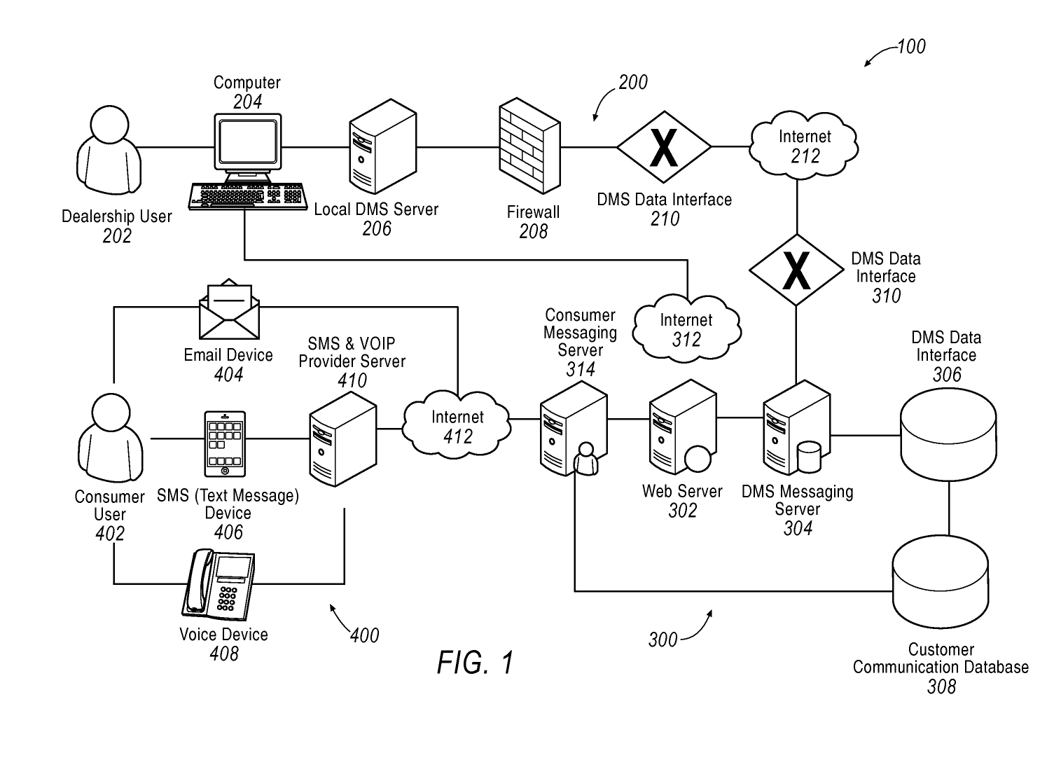

FIG. 1 illustrates an exemplary communication system 100. System 100 may include subsystem 200, subsystem 300, and subsystem 400. Subsystem 200 may be configured to communicate information with dealership user 202 and include computer 204, local DMS server 206, firewall 208, and DMS data interface 210. Subsystem 300 may include web server 302, DMS messaging server 304, dealer DMS data interface 306, customer communication database 308, DMS data interface 310, and customer messaging server 314. Subsystem 400 may be configured to communicate information with customer user 402 and may include messaging (e.g., e-mail) device 404, messaging (e.g., SMS) device 406, voice device 408 (e.g., a phone), and SMS & VOIP provider server 410. The messaging device 404, messaging device 406, and voice device 408 may be integrated in a single or any number of discrete devices. Internet 212 may connect DMS data interface 210 with DMS data interface 310. Internet 312 may connect computer 204 with web server 302. Internet 412 may connect customer messaging server 314 with messaging device 404 and SMS & VOIP provider server 410. The computing systems and/or devices such as the computers, servers, and other devices discussed herein may include a processor, memory, and a user interface such as a display. System 100 may take many different forms and include multiple and/or alternate components and facilities. While an exemplary system 100 is shown in FIG. 1, the exemplary components illustrated in Figure are not intended to be limiting. Indeed, additional or alternative components and/or implementations may be used. Examples of computing devices include, without limitation, mobile phones, computer workstations, servers, desktops, notebooks, laptops, tablets, handheld computers, or any other computing system and/or device.

The computing systems and/or devices herein may also include computer-executable instructions, where the instructions may be executable by one or more computing devices such as those listed above. The instructions when executed by the processor may cause the processor to provide any of the operations discussed herein. Computer-executable instructions may be compiled or interpreted from computer programs created using a variety of programming languages and/or technologies. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., a program) on one or more computing devices (e.g., servers, personal computers, etc.), stored on computer readable media associated therewith (e.g., disks, memories, etc.). A computer program product may comprise such instructions stored on computer readable media for carrying out the functions described herein.

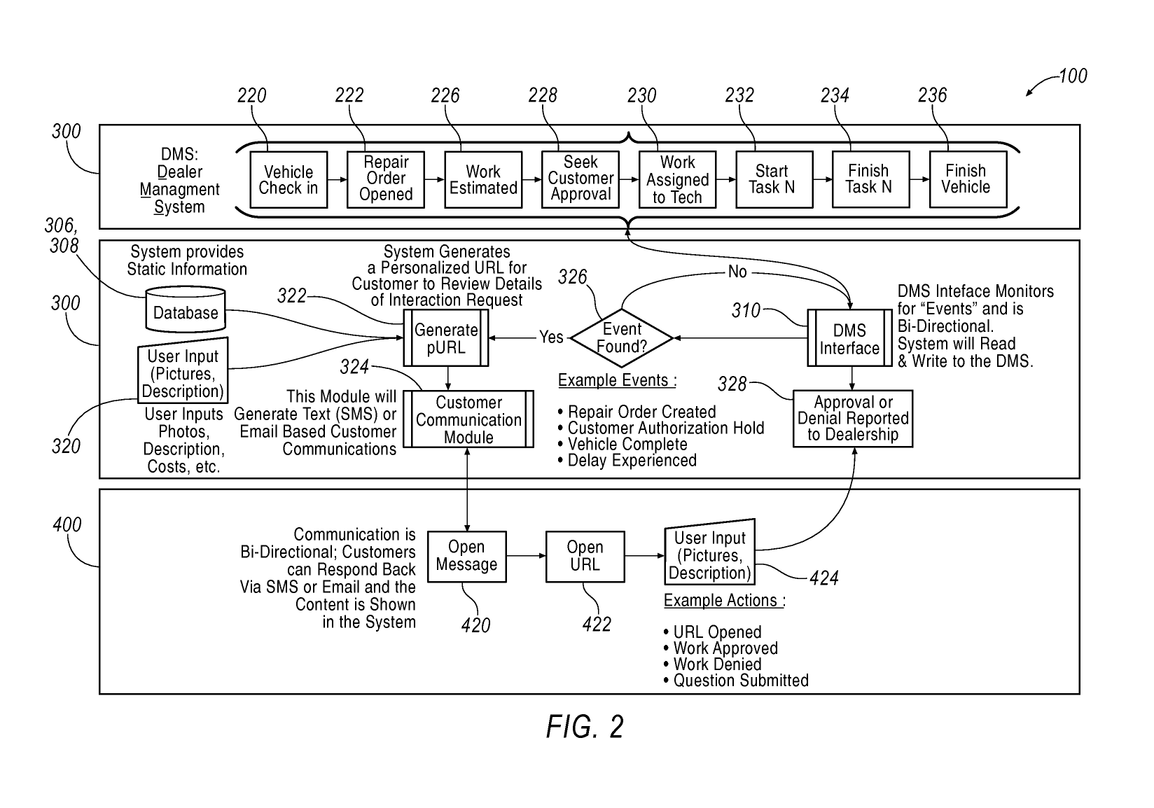

An exemplary vehicle notification process is illustrated in FIG. 2. Subsystem 200 may include a dealer management system (DMS). Subsystem 200 may utilize one or more processors, memories, databases, and user interfaces. The subsystem 200 may be configured to receive, store, and display data regarding operations including vehicle check-in 220 by dealership user 202, repair order opened 222, work estimated 226, seek customer approval 228, work assigned to tech 230, start task 242, finish task 234, and finish vehicle 236.

Subsystem 300 may include DMS interface 310. Subsystem 300 may utilize one or more processors, memories, databases, and user interfaces. DMS data interface 310, using a processor, may be configured to monitor for events. DMS data interface may be configured to make bi-directional reads and writes to one or more databases the dealer management system of subsystem 200. Event 326 may include vehicle status information, for example, repair order created, customer authorization hold, vehicle complete, or delay experienced. If event 326 is present, subsystem 300 integrates event information into personalized URL 322. If event 326 is not present, subsystem 300 indicates this to subsystem 200.

Subsystem 300 integrates content from event 326, databases 306 and 308, and user input 320 to generate personalized URL 322 for customer user 402. User input 320 may include any information that may need to be communicated between the dealership user 202 and customer user 402, for example photos, description, and costs. After the personalized URL 322 is created, customer communication module 324 generates and sends an SMS or e-mail with personalized URL 322.

Subsystem 400 may include open message 420, open URL 422, and response 424. Subsystem 400 may utilize one or more processors, memories, databases, and user interfaces. Subsystem 300 and 400 include bi-directional communications where customers can respond 424 to a call to action via SMS or e-mail while the communication history is shown on the internet dashboard. The actions of customer user 402 are tracked while at the URL. For example, actions may include URL opened, work approved, work denied, or question submitted. Response 424 results in report 328 of approval or denial being communicated to the dealership via DMS data interface 310.

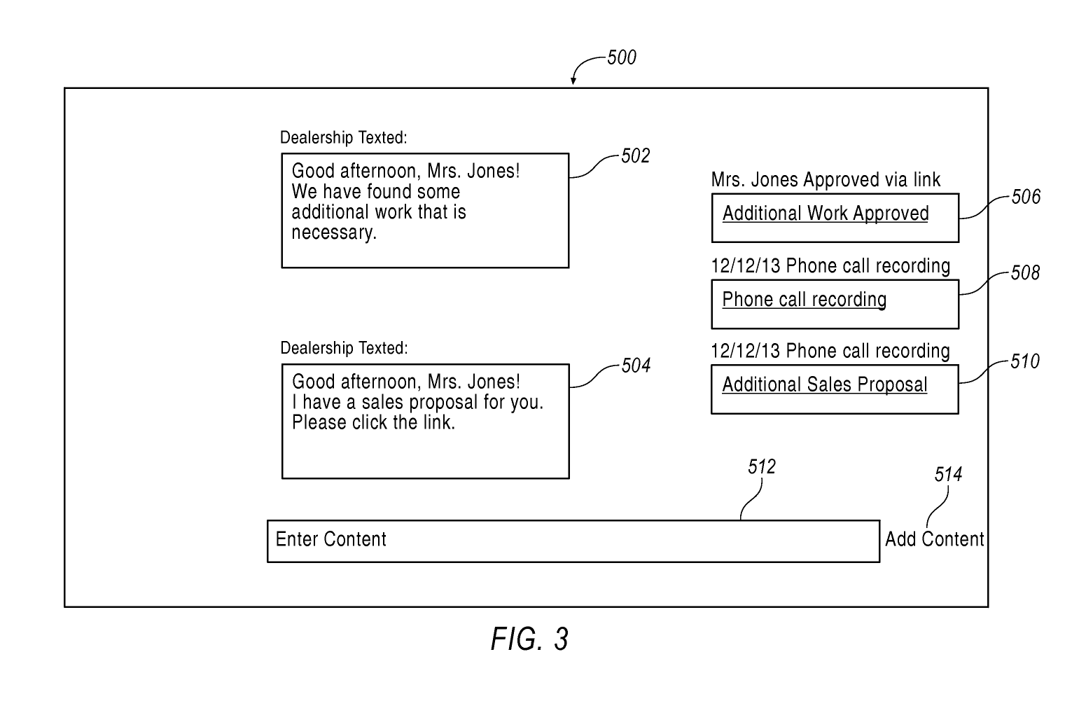

FIG. 3 provides a graphical representation of an exemplary user interface 500. The user interface 500 may allow a service facility to notify a customer of additional work 502 or a sales proposal 504, for example by providing a link. The customer may approve additional work 506, receive communications 508 (e.g., phone calls) from the service facility, receive and approve additional sales proposals 510, enter content 512, and add content 514.

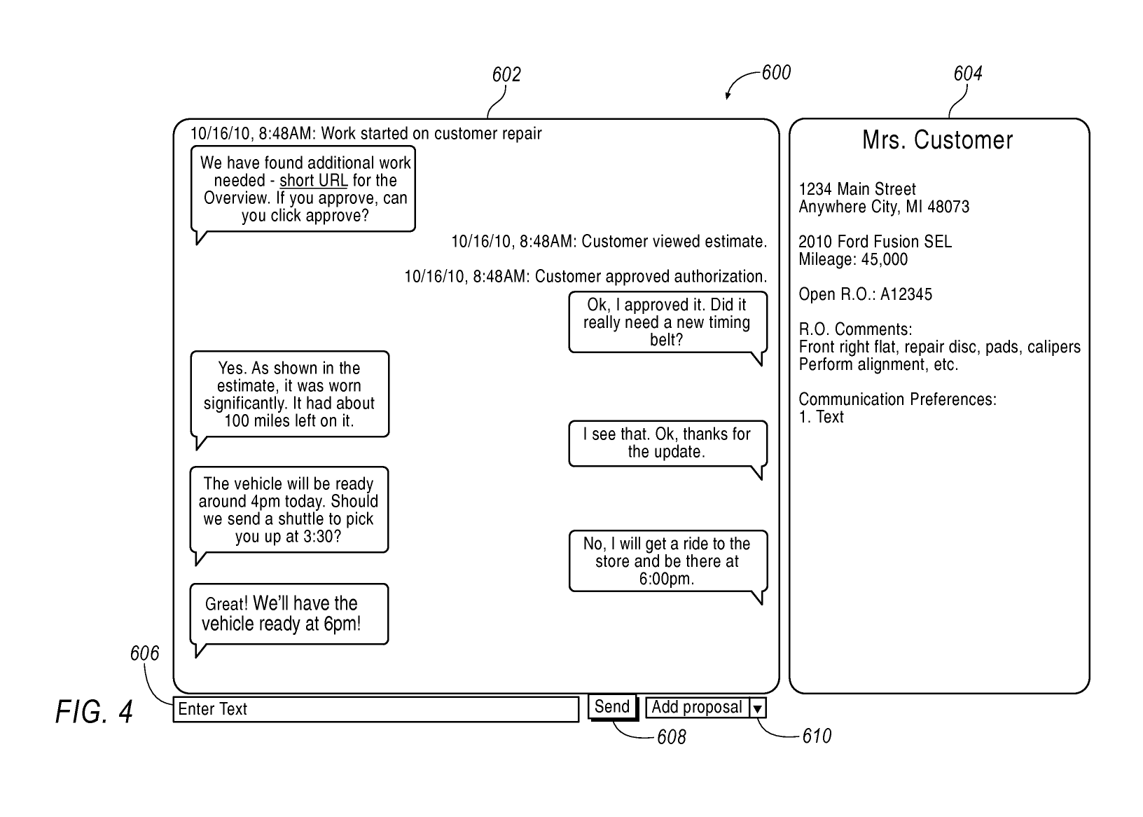

Further, FIG. 4 provides another graphical representation of an exemplary user interface 600. The user interface 600 may include a first window 602, a second window 604, a text entry portion 606, a send button 608, and a drop-down menu 610 (e.g., to add a proposal). The user interface 600 may allow a service facility to notify the customer of additional work, provide a URL, and request approval for the work. The user interface may also provide an estimate, vehicle status (e.g., work started, estimate viewed, customer approved, etc.), details of the required repairs, estimated completion time, and confirm a pickup time. The customer may approve additional work, request additional details about the work, confirm understanding of the vehicle condition, and indicate how and when the customer will pick-up the vehicle. The user interface may also provide the customer name, customer address, vehicle description, mileage, repair order number, repair order details (e.g., required repairs and desired services), and communication preferences (e.g., text message). The user interface 600 may further allow the service facility and customer to add contents using the text entry portion 606 and add documents (e.g., proposals) using the drop-down menu 610.

It may be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it may be appreciated that the various modifications and changes can be made to these embodiments without departing from the scope of the present disclosure as set forth in the claims. The specification and the drawings are to be regarded as an illustrative thought instead of merely restrictive thought.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for automated communication of a vehicle status with a customer, comprising:
a computing device having a processor and memory, the processor configured to receive contact information of the customer and vehicle status from a vehicle service facility;
a database in communication with the computing device and configured to store the contact information and vehicle status;
a user interface in communication with the database and configured to present the vehicle status; and
a server configured to automatically send a link associated with the internet dashboard.

2. The system of claim 1, wherein the computing device is associated with at least one of the customer and the vehicle service facility.

3. The system of claim 1, wherein the server sends the link to a mobile device associated with the contact information of the customer.

4. The system of claim 1, wherein the server sends the link in response to updating the vehicle status.

5. The system of claim 1, wherein the database receives at least a first channel and a second channel of communication data.

6. The system of claim 5, wherein the server combines the first and second channels into one communication thread.

7. The system of claim 5, wherein the user interface displays the communication thread including at least a portion of each of the first and second channels.

8. The system of claim 5, wherein the first channel includes e-mail, the second channel includes SMS, and a third channel includes voice communications.

9. The system of claim 1, wherein the user interface includes an internet dashboard.

10. A method for automated communication of a vehicle status with a customer comprising:
accessing, by way of a user interface of a computing device in communication with a database of a vehicle service facility, an internet dashboard including at least one of an e-mail, SMS, and voice communication regarding the vehicle status;
updating, by way of the user interface, the vehicle status of the database in response to at least a portion of task being performed by the vehicle service facility;
presenting the vehicle status on the internet dashboard;
automatically sending a link for the internet dashboard to the customer;
receiving, by way of the user interface, a customer response from the customer; and
presenting the customer response on the internet dashboard.

11. The method of claim 10, further comprising:
automatically sending a second link for an invoice on the internet dashboard to the customer in response to completion of the task is indicated to the computer.

12. The method of claim 10, wherein completion of the task is indicated by the vehicle service facility.

13. The method of claim 10, further comprising:
providing customer contact information to a database of the vehicle service facility;
providing the vehicle status to the database; and
automatically sending the vehicle status to a mobile device associated with the customer contact information.

14. The method of claim 10, further comprising:
receiving customer contact information into a computer connected to a database of a vehicle service facility, the database being connected to an internet dashboard;
receiving the vehicle status into the database from the vehicle service facility, the vehicle status being reflected on the internet dashboard; and
automatically sending an internet link of the internet dashboard to a mobile device associated with the customer contact information.

15. A computing device for automated communication of a vehicle status with a customer, the computing device having a processor and memory, the processor being configured to perform operations comprising:
access an internet dashboard including at least one of an e-mail, SMS, and voice communication regarding a vehicle status;
update the vehicle status in response to at least a portion of task being performed by the vehicle service facility;
present the vehicle status on the internet dashboard;
automatically send a link for the internet dashboard to the customer;
receive a response of the customer; and
present the customer response on the internet dashboard.

16. The system of claim 15, wherein the computing device is associated with at least one of the customer and the vehicle service facility.

17. The system of claim 15, the operations further comprising:
automatically send a second link for an invoice on the internet dashboard to the customer in response to completion of the task being indicated by the vehicle service facility.

18. The system of claim 15, wherein completion of the task is indicated by the vehicle service facility.

19. The system of claim 15, the operations further comprising:
provide customer contact information to a database of the vehicle service facility; and
provide the vehicle status from the vehicle repair facility to the database.

20. The system of claim 15, the operations further comprising:
automatically send the vehicle status to a mobile device associated with the customer contact information.
